(19) United States
(12) Patent Application Publication
(10) Pub. No.: US 2009/0158909 A1
(43) Pub. Date: Jun. 25, 2009

(54) Office accessory for hole-punching sheet material

(76) Inventor: Bernd LOIBL, (US)

Correspondence Address: BERENATO, WHITE & STAVISH, LLC, 6550 ROCK SPRING DRIVE, SUITE 240, BETHESDA, MD, 20817, US

(21) Appl. No.: 12/268,641

(22) Filed: Nov. 11, 2008

(30) Foreign Application Priority Data
Nov. 14, 2007 (DE) 202007015983.8

(51) Int. Cl. B26F 1/14

(52) U.S. Cl. 83/687

(57) ABSTRACT

The invention relates to an office accessory (1) for punching, in particular hole-punching, sheet material (2), having a base (3) for receiving the sheet material (2), having at least one stop (4) for positionally accurate positioning of the sheet material (2), and having a punching apparatus (5) for performing the punching operation, which is characterized in that the office accessory (1) comprises a guide bar (6), aligned parallel to the stop (4), on which the punching apparatus (5) is displaceably mounted.

### CROSS-REFERENCE TO RELATED APPLICATIONS AND CLAIM TO PRIORITY

This application is related to utility model application no. 20 2007 015 983.8, filed Nov. 14, 2007 in the Federal Republic of Germany, to which priority is claimed.

### FIELD OF THE INVENTION

The present invention relates to an office accessory for punching, in particular hole-punching, sheet material, having a base for receiving the sheet material, having at least one stop for positionally accurate positioning of the sheet material, and having a punching apparatus for performing the punching operation.

### BACKGROUND OF THE INVENTION

Office accessories of the kind cited above are generally known and described, for example, in DE 32 27 301 C2. They serve for hole-punching of paper sheet material, usually in the DIN A4 format. Unpunched sheets of paper are usually hole-punched by firstly folding them into a two-layer arrangement and then placing them into a hole punch, and then hole-punching them. For this purpose, often the center of the folded sheet is first identified, and is then placed against a positioning marking of the hole punch. Alternatively, a hole punch of this kind is equipped with a laterally mounted bar against which the lower edge of the sheet of paper to be hole-punched is placed for positioning of the sheet in the hole punch. If the sheet of paper is then also to be trimmed to a specific dimension, it is necessary to remove from the hole punch the sheet material that has already been aligned for hole-punching, place it into a separate office accessory having a cutting device, and align it again along a cutting edge of the cutting device.

A further disadvantage of this system is that handling is very complex, since the punching apparatus must be moved into and out of the apparatus from one punching point to another, and at the same time consideration must be given to constantly repositioning the sheet material in the punching apparatus that is to be inserted.

### SUMMARY OF THE INVENTION

It is therefore an object of the present invention to make available an office accessory that enables simpler handling.

This object is achieved, according to the present invention, in that the office accessory comprises a guide bar, aligned parallel to the stop, on which the punching apparatus is displaceably mounted. The result of this is that after positioning, in or relative to the punching apparatus, of the sheet material to be processed, the hole pattern can be introduced by simply displacing the punching apparatus in the guide bar.

In order to allow use of a more flexible hole-punching configuration, for example by the use of different punching devices having a different punching pattern, it is advantageous to embody the punching apparatus removably from the guide bar.

In order to generate a consistently reproducible punching pattern, for example a constant spacing of the punched holes with respect to one another, in an exemplifying embodiment of the present invention the office accessory can comprise stop elements, arranged along the guide bar, which enable fastening of the sheet material in specific punching positions in a reproducible fashion.

In a further embodiment of the present invention, the stop elements are embodied so that in a stop position they project into the movement region of the punching apparatus, and are movable out of the stop position out of the movement region of the punching apparatus, into a release position. The result of this is that in the punching positions, the punching apparatus is prevented by the stop elements from moving further within the guide bar, and after the punching operation it can be moved on when the stop elements are shifted into the release position. For that purpose, the stop elements either can be taken entirely out of the movement region of the punching apparatus, or else can be arranged so that after moving into the release position, the stop elements can be traveled over by the punching apparatus.

As an alternative to actively moving the stop elements out of the movement region of the punching apparatus, in a further exemplifying embodiment the stop elements can be moved automatically into the release position by the punching apparatus after overcoming a resistance. This can be achieved, for example, in that the stop elements are spring-loaded toward the stop position.

Particularly simple handling of the office accessory is enabled by the fact that the stop elements are each embodied as a detent device active between the base and guide bar on the one hand, and the punching apparatus on the other hand. It is advantageous for that purpose if the detent device is displaceable into a cavity below the bed upon movement of the punching apparatus, and return to the starting position after being traveled over by the punching apparatus.

The detent devices can be embodied integrally, for example by way of a flange in the form of a rocker, or can each be embodied as separate modules.

In order to facilitate displacement of the punching apparatus within the guide bar, provision is made in an exemplifying embodiment to embody the stop elements with wedge-shaped, beveled edge regions. For that purpose, in a preferred exemplifying embodiment, the stop elements are embodied in pyramid-like fashion in the contact region with the punching apparatus.

A particularly space-saving and user-friendly embodiment of the present invention provides for embodying the stop elements within the guide bar. The stop elements can of course also be arranged in this fashion above and/or below the guide bar.

In a further advantageous exemplifying embodiment, the office accessory according to the present invention is equipped with at least one cutting device with which the sheet structure is trimmable along and/or perpendicular to and/or at an, in particular, adjustable angle relative to, the stop. This makes it possible for the sheet structure requiring processing to be processed completely in the office accessory with no need, for that purpose, to remove the sheet structure from the office accessory or align it repeatedly; this is equivalent to a reduction in error sources during processing.

The cutting device can be embodied, for example, as a guillotine cutting device, a blade cutter, or also as a rotary cutting device. Other further cutting devices that are known in the existing art can likewise be utilized.

In an exemplifying embodiment of the present invention, a holddown for pressing the sheet material onto the sheet-material support surface is to be arranged alongside the cutting device, the holddown being movable between a raised starting position and a pressing position offset toward the bed. A holddown of this kind is described, for example, in EP 1 754 578 A1, to the entirety of which reference is hereby made.

According to a further feature of the invention, as described e.g. in EP 1475 201 B1, to the entirety of which reference is hereby made, provision is made that the cutting device is raisable out of a lower cutting position into an upper starting position, and is movable therefrom back into the cutting position. The gap between the bed and cutting device can be embodied to be inaccessible from the end faces of the cutting device. As a result it becomes possible not to carry out the vertical movement of the circular knife of the cutting device by way of a knife carriage provided on the cutting device, but rather to effect it by means of the cutting device itself, by firstly raising the cutting device in order to slide the sheet stock through, and then lowering it into the cutting position in which the circular knife rests on the bed. This makes handling of the cutting operation substantially simpler, and results in cleaner cuts. It is particularly important that the gap between the cutting device and bed be inaccessible from the end faces of the guide bar, i.e. be covered there, so that it is not possible for the operator's fingers to get into the gap in this region and become caught when the guide bar is lowered.

In a further embodiment of the invention, it is proposed that the guide bar be guided in vertically displaceable fashion in the region of its end faces, so that it can be raised and lowered parallel to the bed, preferably by no more than 20 mm, and even more preferably by an amount equal to 12 mm. Alternatively thereto, however, provision can also be made for the cutting device to be mounted pivotably about a horizontal axis in the region of one end face, through an angle at most of 10°, preferably of 4 to 5°.

The cutting device can be suspended in such a way that it assumes, without actuation, the cutting position in which the rotary knife rests on the bed. The cutting device can be raised manually in order to slide the sheet material through the gap between the cutting device and bed. Alternatively thereto, however, the possibility also exists that the cutting device is held, without actuation, in the starting position by means of a spring. This facilitates sliding of the sheet material through the gap, but requires the guide bar to be pushed down for the cutting operation. A clean cut is achieved with this embodiment as well, however, since it is possible to push down the guide bar with one hand and displace the knife carriage with the other hand; this is considerably easier to handle than with the known rotary cutting devices, in which the knife carriage must be pushed down and simultaneously displaced.

Provision is furthermore made according to the present invention that the guide bar is fastenable in the cutting position, at its vertically movable end(s), with a blocking device or devices. The guide bar is thereby immobilized for the cutting operation and cannot move by itself, and need not be pushed down during the cutting operation when that is counteracted by a spring. This simplifies operation of the cutting device.

The (or each) blocking device is preferably embodied as a snap device into which the cutting device snaps automatically and disengageably upon movement into the cutting position, so that immobilization of the guide bar in the cutting position is not associated with additional manipulations. Only for the disengagement operation after the cutting operation is an actuation of the snap device necessary, for the purpose of disengaging it. The snap device can comprise for that purpose an actuation slider that is mounted at a favorable location.

To allow the dimensions of the sheet material to be determined prior to trimming, in an exemplifying embodiment at least one measurement device is provided on the office accessory. The measurement devices can, for example, be mounted on the office accessory via a folding mechanism, and can be constituted by a ruler or a measuring roller device.

### BRIEF DESCRIPTION OF THE DRAWINGS

The invention will be further explained below with reference to the attached drawings, in which:

FIG. 1 is a perspective depiction of an office accessory according to the present invention;

FIG. 2 is a perspective depiction of the hole-punching operation in an office accessory in accordance with FIG. 1;

FIG. 3 schematically depicts the cutting operation in an office accessory in accordance with FIG. 1;

FIG. 4 is a plan view of an office accessory according to the present invention in accordance with FIG. 1; and

FIG. 5 is a sectioned depiction along section lines B-B and E-E of FIG. 4.

### DETAILED DESCRIPTION OF THE PREFERRED EMBODIMENT(S)

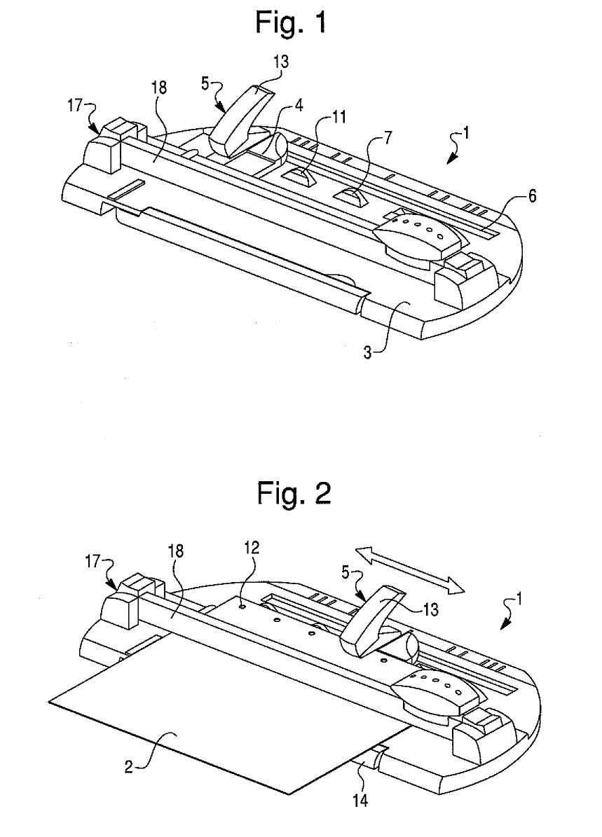

FIG. 1 shows an office accessory 1 according to the present invention for punching, in particular for hole-punching, sheet material 2, having a base 3 for receiving sheet material 2 and having a stop 4 for positionally accurate positioning of sheet material 2 within office accessory 1. In this exemplifying embodiment, stop 4 is embodied in a punching apparatus 5.

Punching apparatus 5 is inserted into a guide bar 6 aligned parallel with stop 4, and supported displaceably therein (as indicated with arrows) in order to introduce into sheet material 2 punched holes that are each at a consistent spacing from the edge region, resting against stop 4, of sheet material 2. Punching apparatus 5 is removable from guide bar 6, thereby enabling a more flexible configuration of the hole pattern, for example by the use of different punching devices having different punching patterns.

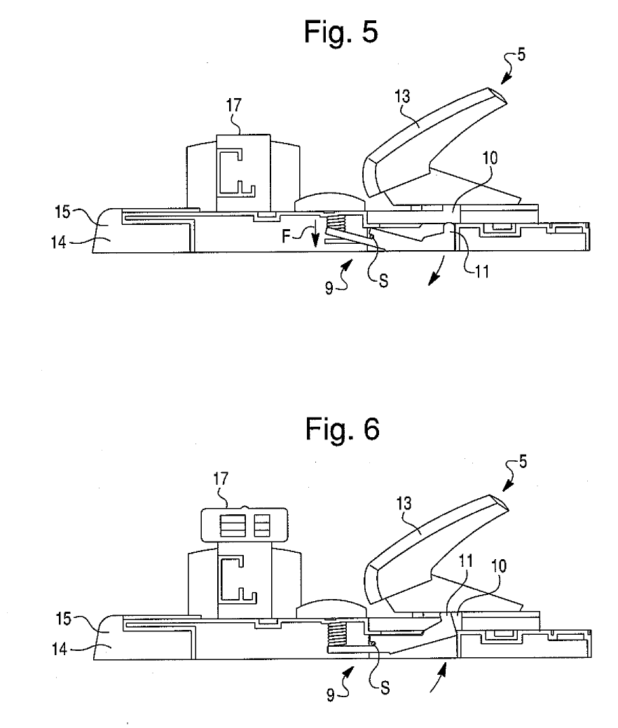

Provided along guide bar 6 are multiple stop elements 7 with which sheet material 2 is reproducibly positionable in punching apparatus 5. Stop elements 7 are arranged at regular spacings from one another within guide bar 6. They comprise a detent mechanism 9 active between bed 3 or guide bar 6 on the one hand, and punching apparatus 5 on the other hand (see also FIG. 5). For the actuation of detent mechanism 9, upon a movement of punching apparatus 5 along guide bar 6, stop elements 7 are firstly pivoted against a spring force F into a cavity below guide bar 6. For that purpose, stop elements 7 are journaled about a pivot axis S and are moved around pivot axis S upon displacement of punching apparatus 5.

In a first embodiment of the present invention, all the stop elements 7 are simultaneously pivoted together into the region below guide bar 6, by way of a common rocker, when punching apparatus 5 travels over only one stop element 7. In a further alternative exemplifying embodiment, each individual stop element 7 is separately equipped with an independent pivoting mechanism 9.

Stop elements 7 are embodied in pyramid-like fashion in the contact region with punching apparatus 5, and comprise wedge-shaped rounded edge regions to overcome more easily a resistance generated by spring force F, so that punching apparatus 5 can therefore travel over them more easily.

To allow punched holes to be introduced into sheet material 2 in reproducible fashion, firstly sheet material 2 is placed into office accessory 1 and is slid further into office accessory 1 until it comes into contact against stop 4 and/or stop elements 7 of punching apparatus 5. The first punched hole 12 is introduced when punching apparatus 5 is in a first end position within guide bar 6 of office accessory 1, by the fact that a lever 13 of punching apparatus 5 is moved downward. Punching apparatus 5 is then moved toward the second end region of guide bar 6 until it has reached a second defined punching position.

Upon reaching the punching position, punching apparatus 5 is prevented by positioning elements (not depicted) from moving further, by the fact that they decelerate or stop the movement of punching device 5. A further punched hole 12 can then be introduced into sheet material 2 by another actuation of lever 13 of punching device 5 by the user. In this exemplifying embodiment, the spacing of punched holes 12 with respect to one another corresponds exactly to the spacings of the individual positioning elements.

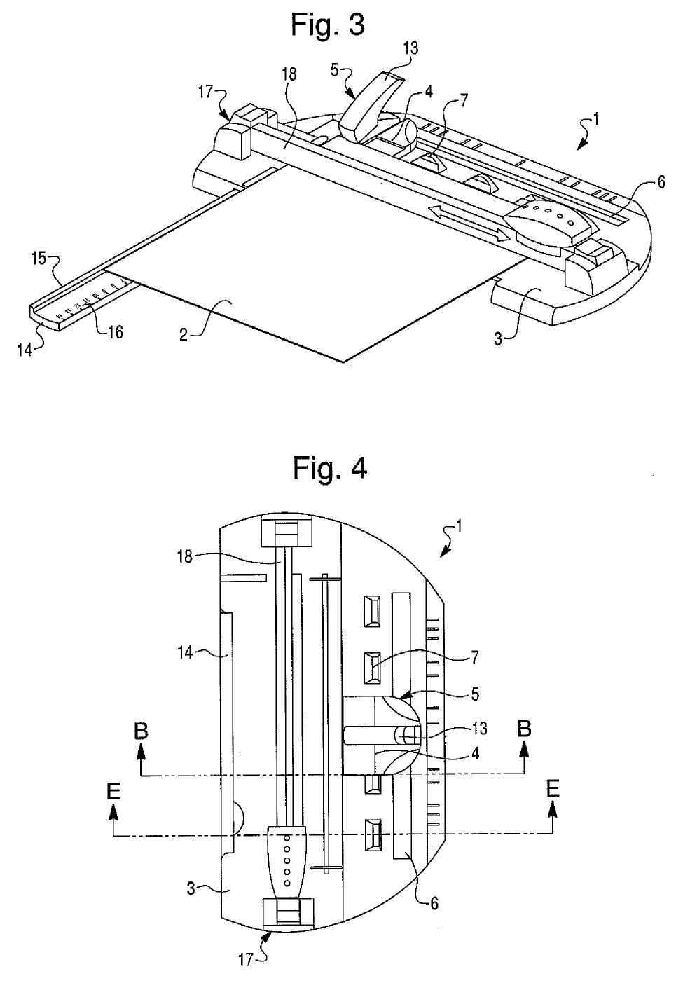

FIG. 3 shows a measurement device in the form of a ruler 14, having a folding mechanism, provided on office accessory 1. A further stop 15 for sheet material 2 to be processed is provided on ruler 14; this substantially enhances flexibility for the processing of sheet material 2, since sheet material 2 thus does not absolutely need to be laid against stop 4, or against the stop elements of punching apparatus 5, for further positionally accurate processing. A scale 16 on ruler 14 gives the user the capability, once punching of sheet material 2 has been successfully performed, of displacing said material in office accessory 1 until the edge length of the peripheral region parallel to stop 15 of measuring device 14 has reached a specific value. Sheet material 2 is then trimmed with a cutting device 17 provided on office accessory 1 and aligned below stop 3 parallel to stop 3. Cutting device 17 is a rotary cuffing device that comprises a guide bar 18 extending at a distance from bed 3 parallel to stop 4. A knife carriage 19 is guided on guide bar 18 displaceably in the direction of the longitudinal axis of guide bar 18. It can be shifted back and forth manually. A circular knife (concealed here by a knife housing) is mounted on knife carriage 16, rotatably about a horizontal axis extending transversely to the longitudinal axis of guide bar 15. The circular knife projects downward beyond the knife housing.

In this exemplifying embodiment, cutting device 5 is guided in vertically displaceable fashion and can be raised 12 mm in order to simplify the insertion of sheet material 4 into a gap between guide bar 15 and bed 3

In order to cut sheet material 2, knife carriage 16 is displaced under slight pressure within guide bar 15, the circular knife (not depicted) located therebelow executing a rotary movement and thereby cutting sheet material 2. The trimmed sheet-material portion resting on base 3, and the cut-off sheet-material portion, remain behind.

To allow the length of the edge region of sheet material 2 perpendicular to cutting device 17 to be defined, without requiring for that purpose a further displacement of sheet material 2 within office accessory 1, in this exemplifying embodiment guide bars (not depicted) are embodied in bed 3; these allow cutting device 17 to be displaced parallel to stop 4 and thereby allow the spacing between stop 4 and cutting device 5 to be adjusted in reproducible fashion and thus made smaller or larger as required.

1. An office accessory (1) for punching, in particular hole-punching, sheet material (2), having a base (3) for receiving the sheet material (2), having at least one stop (4) for positionally accurate positioning of the sheet material (2), and having a punching apparatus (5) for performing the punching operation.
wherein the office accessory (1) comprises a guide bar (6), aligned parallel to the stop (4), on which the punching apparatus (5) is displaceably mounted.

2. The office accessory (1) according to claim 1, wherein the punching apparatus (5) is removable from the guide bar (6).

3. The office accessory (1) according to claim 1, wherein the office accessory (1) comprises multiple stop elements (7), arranged along the guide bar (6), with which the sheet material (4) is reproducibly fastenable in specific punching positions.

4. The office accessory (1) according to claim 3, wherein in a stop position the stop elements (7) project into the movement region of the punching apparatus (5), and are movable out of the stop position out of the movement region of the punching apparatus (5) into a release position.

5. The office accessory (1) according to claim 4, wherein the stop elements are movable into the release position by the punching apparatus (5) after overcoming a resistance.

6. The office accessory (1) according to claim 5, wherein after moving into the release position, the stop elements can be traveled over by the punching apparatus (5).

7. The office accessory (1) according to claim 4, wherein the stop elements are spring-loaded toward the stop position.

8. The office accessory (1) according to claim 3, wherein the stop elements (7) are respectively embodied as detent devices active between the base (3) or guide bar (6) on the one hand, and the punching apparatus (5) on the other hand.

9. The office accessory (1) according to claim 8, wherein the detent devices are displaceable into a cavity below the bed (3) upon movement of the punching apparatus (5), and return to their starting position after being traveled over by the punching apparatus (5).

10. The office accessory (1) according to claim 8, wherein the detent devices are embodied integrally or as separate modules.

11. The office accessory (1) according to claim 3, wherein the stop elements (7) comprise wedge-shaped, beveled edge regions.

12. The office accessory (1) according to claim 3, wherein the stop elements (7) are embodied in pyramid-like fashion in the contact region with the punching apparatus (5).

13. The office accessory (1) according to claim 3, wherein the stop elements (7) are embodied within the guide bar (6).

14. The office accessory (1) according to claim 3, wherein the stop elements (7) are arranged above and/or below the guide bar (6).

15. The office accessory (1) according to claim 1, wherein it comprises at least one cutting device (17) with which the sheet structure (2) is trimmable along and/or perpendicular to and/or at an, in particular, adjustable angle relative to, the stop (3).

16. The office accessory (1) according to claim 15, wherein the cutting device (17) is a guillotine cutting device.

17. The office accessory (1) according to claim 15, wherein the cutting device (17) is a rotary cutting device.

18. The office accessory (1) according to claim 15, wherein a holddown for pressing the sheet material onto the bed (3) is arranged adjacent to the cutting device (17), the holddown being movable between a raised starting position and a pressing position offset toward the sheet-material support surface.

19. The office accessory (1) according to claim 15, wherein the cutting device (17) is alignable relative to the stop (3a) at an angle that is modifiable by way of an adjustment mechanism.

20. The office accessory (1) according to claim 15, wherein the cutting device (17) is guided displaceably parallel to the stop (3a).

21. The office accessory (1) according to claim 15, wherein the cutting device (17) is raisable out of a lower cutting position into an upper position, and is lowerable therefrom back into the cutting position.

22. The office accessory (1) according to claim 15, wherein the cutting device (8) is inaccessible from the end faces of the cutting device (17).

23. The office accessory (1) according to claim 15, wherein the cutting device (17) is guided in vertically displaceable fashion in the region of its end faces.

24. The office accessory (1) according to claim 21, wherein the cutting unit (17) is raisable 5 to 20 mm.

25. The office accessory (1) according to claim 21, wherein the cutting device (17) is fastenable in the cutting position, at its vertically movable end(s), by means of a blocking device or devices.

26. The office accessory (1) according to claim 25, wherein the or each blocking device is embodied as a snap device into which the cutting device (17) snaps automatically and disengageably upon movement into the cutting position.

27. The office accessory (1) according to claim 26, wherein the snap device comprises an actuation slider with which the snap device is disengageable.

28. The office accessory (1) according to claim 1, wherein it comprises at least one a measurement device (14), in particular a ruler, for determining the dimensions of the sheet material (2).

29. The office accessory (1) according to claim 28, wherein the measurement device (14) is mounted on the office accessory (1) via a folding mechanism.
